(19) United States
(12) Patent Application Publication
(10) Pub. No.: US 2011/0039135 A1
(43) Pub. Date: Feb. 17, 2011

(54) LIQUID POWERED ASSEMBLY

(75) Inventors: MARK A. BEDOL, Claremont, CA (US); Kohar Scott, Hawthorne, CA (US)

Correspondence Address: LAWRENCE N. GINSBERG, 21 SAN ANTONIO, NEWPORT BEACH, CA, 92660-9112, US

(73) Assignee: Mark A. Bedol, Claremont, CA (US)

(21) Appl. No.: 12/541,432

(22) Filed: Aug. 14, 2009

(51) Int. Cl. H01M 2/08

(52) U.S. Cl. 429/50; 429/185; 429/174

(57) ABSTRACT

A liquid powered assembly including a housing; a removable bottom base; a seal; an electrolyte battery assembly; and, a liquid powered device. The housing includes an upper end portion and a lower end portion. The housing has a volume therein for containing an electrolyte solution. The lower end portion has a fluid inlet. The removable bottom base is removably attached to the lower end portion of the housing. The removable bottom base has a bottom surface for supporting the liquid powered assembly. A seal engages the housing and the removable bottom base for providing fluidic sealing engagement therebetween. An electrolyte battery assembly is positioned within the housing. A liquid powered device is operably attached to the electrolyte battery assembly. To provide operation, the housing and the removable bottom base are detached relative to each other and the housing is turned substantially upside down to allow filling of the housing via the inlet. The bottom base is then attached to the housing and the assembly is then inverted for use.

### BACKGROUND OF THE INVENTION

1. Field of the Invention

The present invention relates to portable electrolyte powered devices and more particularly to a liquid powered assembly that utilizes a removable bottom base for sealing the housing that contains the electrolyte solution.

2. Description of the Related Art

Electrolyte solutions are known in the prior art for providing power to operate very low power consumption devices such as clocks and calculators. For example, Bedol International Group, Inc., Claremont, Calif., distributes a portable “Water Clock” that is operated by a solution of water and lemon (or alternatively salt). The Bedol “Water Clock” includes a cap that extends from an upper portion of the housing of the device.

Present applicants are also the inventors of the invention disclosed in U.S. Ser. No. 29/313,579, filed on Jan. 23, 2009, entitled “Clock”.

### SUMMARY OF THE INVENTION

In a broad aspect, the present invention is a liquid powered assembly including a housing; a removable bottom base; a seal; an electrolyte battery assembly; and, a liquid powered device. The housing includes an upper end portion and a lower end portion. The housing has a volume therein for containing an electrolyte solution. The lower end portion has a fluid inlet. The removable bottom base is removably attached to the lower end portion of the housing. The removable bottom base has a bottom surface for supporting the liquid powered assembly. A seal engages the housing and the removable bottom base for providing fluidic sealing engagement therebetween. An electrolyte battery assembly is positioned within the housing. A liquid powered device is operably attached to the electrolyte battery assembly. To provide operation, the housing and the removable bottom base are detached relative to each other and the housing is turned substantially upside down to allow filling of the housing via the inlet. The bottom base is then attached to the housing and the assembly is then inverted for use.

One advantage of the present invention is that in use the filling inlet is disguised. Additionally, the present invention provides enhanced surface area for branding the device or adding other graphical enhancements.

### BRIEF DESCRIPTION OF THE DRAWINGS

FIG. 1 is a perspective view of the liquid powered assembly of the present invention, shown assembled.

FIG. 2 is an exploded perspective view of the liquid powered assembly.

FIG. 3 is a cross-sectional view of the liquid powered assembly in a filled operable state.

FIG. 4 is a perspective view of the liquid powered assembly, shown inverted and being filled for operation.

### DETAILED DESCRIPTION OF THE INVENTION

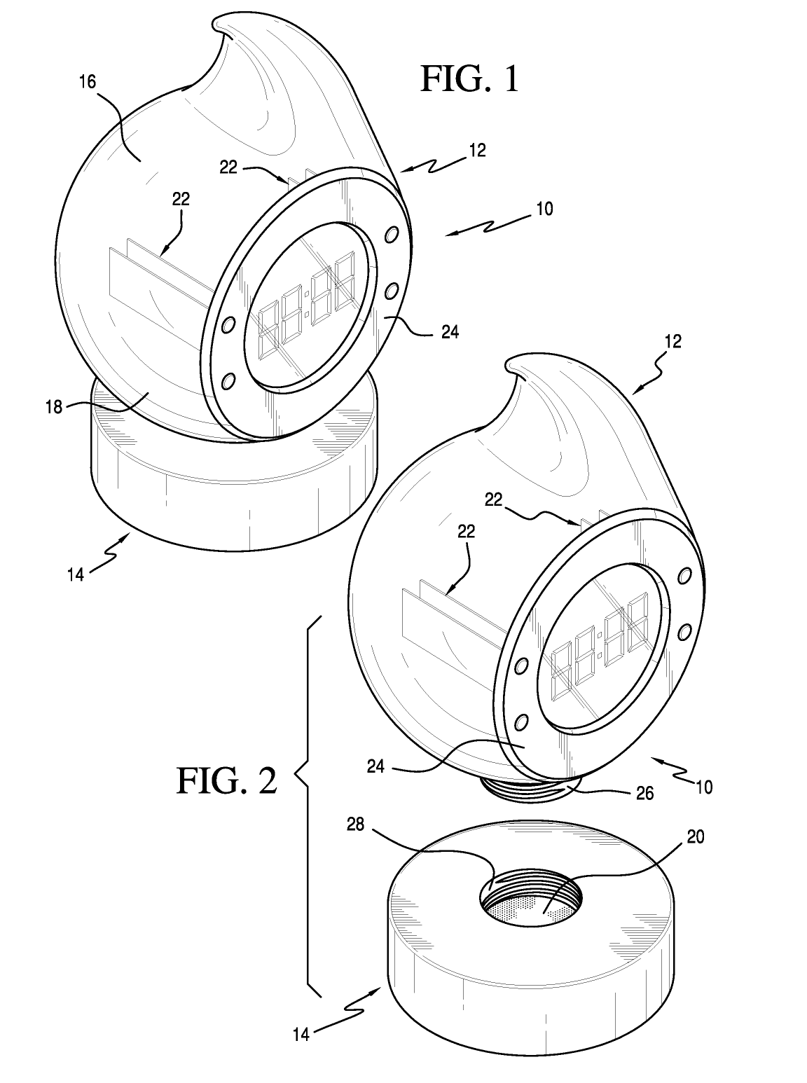

Referring to the drawings and the characters of reference marked thereon, FIGS. 1 and 2 illustrate the liquid powered assembly, designated generally as 10. The assembly 10 includes a housing, designated, generally as 12; and, a removable bottom base, designated generally as 14. The housing 12 includes an upper end portion 16 and a lower end portion 18. The removable bottom base 14 is removably attached to the lower end portion 18 of the housing 12. The removable bottom base 14 has a bottom surface for supporting the liquid powered assembly 10 on a support surface such as a table top or shelf. A seal 20 engages the housing 12 and the removable bottom base 14 for providing fluidic sealing engagement therebetween. An electrolyte battery assembly 22 is positioned within the housing 12. A liquid powered device 24 is operably attached to the electrolyte battery assembly.

The lower end portion 18 of the housing 12 includes a stem 26 defining the fluid inlet. The stem 26 is threaded. The housing 12 may be manufactured in two parts that are bonded together by, for example, ultrasonic welding.

The removable, cylindrical, bottom base 14 has a cavity formed in an upper end thereof. The sides 28 of the cavity contain threads for engaging the threads of the stem 26. The seal 20, i.e. a circular rubber washer, is positioned at the bottom of cavity.

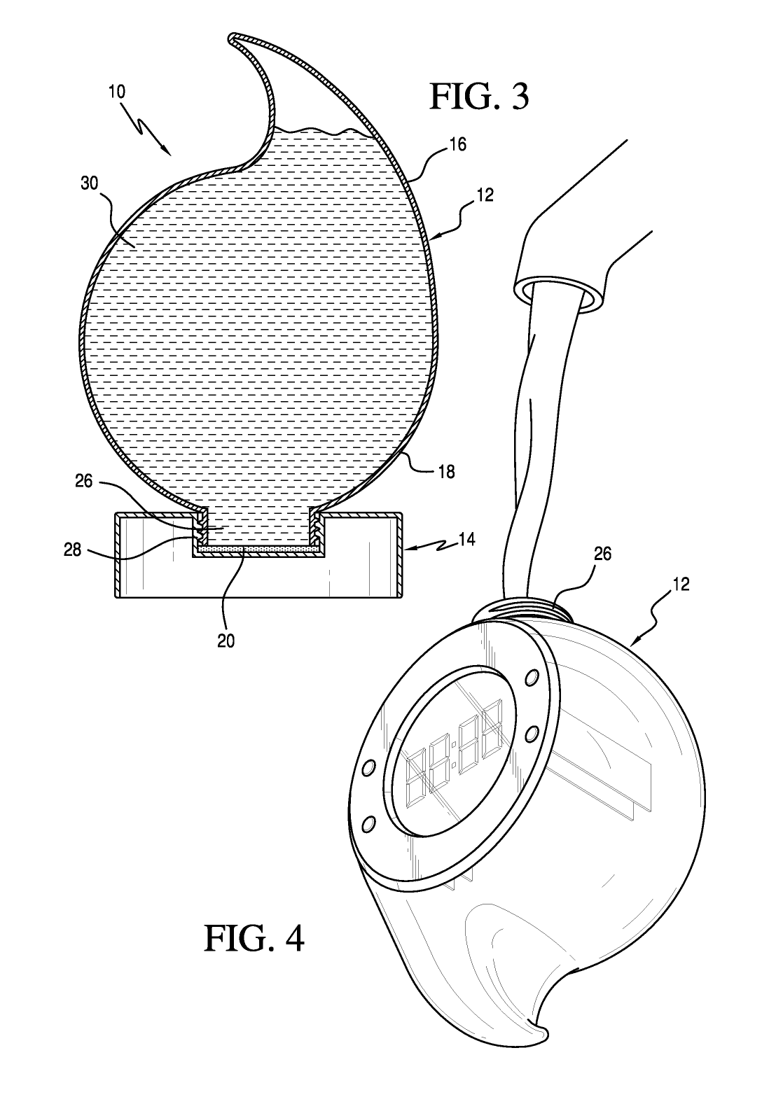

The electrolyte battery assembly 22 preferably comprises two sets of metal rods. Each set includes a brass rod and a zinc rod. During operation, as shown in FIG. 3, the assembly 10 is filled with an electrolyte solution 30 including water with, for example, some lemon juice or salt. Thus, electricity is generated as well known by those familiar with these liquid batteries.

The liquid powered device 24 may be any number of devices, for example, a clock, calculator, or a light.

To fill the liquid powered assembly 10, the housing it detached from the bottom base. This is easily accomplished. The bottom surface of the bottom base has a diameter in a range of between about 2.5 inches and 3.5 inches, preferably about 3 inches. Therefore, the bottom base is easily manipulated.

The housing 12 is grasped and turned substantially upside down, as shown in FIG. 4. The housing is then filled with an electrolyte solution. The bottom base 14 is then attached to the housing 12 to complete the assembly 10. The assembly 10 is then inverted again so that the base 14 can be placed on a support surface with the upper end portion 16 of the housing 12 positioned to be on top.

Other embodiments and configurations may be devised without departing from the spirit of the invention and the scope of the appended claims.

1. A liquid powered assembly, comprising:
a) a housing including an upper end portion and a lower end portion, said housing having a volume therein for containing an electrolyte solution, said lower end portion having a fluid inlet;
b) a removable bottom base removably attached to said lower end portion of said housing, said removable bottom base having a bottom surface for supporting said liquid powered assembly;
c) a seal for engaging said housing and said removable bottom base for providing fluidic sealing engagement therebetween;
d) an electrolyte battery assembly positioned within said housing; and,
e) a liquid powered device operably attached to said electrolyte battery assembly, wherein,
to provide operation, said housing and said removable bottom base are detached relative to each other, said housing is turned substantially upside down to allow filling of said housing via said inlet, said bottom base is attached to said housing and said assembly is then inverted for use.

2. The liquid powered assembly of claim 1, wherein said lower end portion of said housing comprises a stem defining said fluid inlet, said stem being threaded to engage threads within said removable bottom base.

3. The liquid powered assembly of claim 2, wherein said removable bottom base comprises a cavity formed in an upper end thereof, the sides of said cavity containing said threads thereof for engaging said threads of said stem; and, said seal comprises a circular rubber washer positioned at the bottom of said cavity.

4. The liquid powered assembly of claim 1, wherein said removable bottom base is cylindrical.

5. The liquid powered assembly of claim 1, wherein bottom base is cylindrical, said bottom surface thereof having a diameter in a range of between about 2.5 inches and 3.5 inches.

6. The liquid powered assembly of claim 1, wherein said electrolyte battery assembly comprises two sets of metal rods.

7. The liquid powered assembly of claim 1, wherein said liquid powered device comprises a clock.

8. A method of operating a liquid powered assembly, comprising the steps of:
a) providing a housing including an upper end portion and a lower end portion, said housing having a volume therein for containing an electrolyte solution, said lower end portion having a fluid inlet, said housing having a electrolyte battery assembly positioned therewithin and a liquid powered device operably attached to said electrolyte battery assembly;
b) providing a removable bottom base removably attachable to said lower end portion of said housing, said removable bottom base having a bottom surface for supporting said liquid powered assembly;
c) grasping said housing and turning it substantially upside down to expose said fluid inlet of said lower portion of said housing;
d) filling said housing via said inlet, with an electrolyte solution;
e) attaching said bottom base to said housing to complete the assembly; and,
f) inverting said liquid powered assembly so that the base is supported on a support surface and said upper end portion of the housing is positioned to be on top.
